(19) United States
(12) Patent Application Publication
(10) Pub. No.: US 2024/0062237 A1
(43) Pub. Date: Feb. 22, 2024

(54) INFORMATION PROCESSING METHOD AND APPARATUS

(71) Applicants: Beijing Wodong Tianjun Information Technology Co., Ltd., Beijing (CN); Beijing Jingdong Century Trading Co., Ltd., Beijing (CN)

(72) Inventor: Yingshuai WANG, Beijing (CN)

(21) Appl. No.: 17/766,913

(22) PCT Filed: Dec. 28, 2020
(86) PCT No.: PCT/CN2020/140158

§ 371 Date: Apr. 6, 2022

(30) Foreign Application Priority Data
Feb. 28, 2020 (CN) 202010129833.3

(51) Int. Cl. G06Q 30/0207; G06Q 30/0211

(52) U.S. Cl. CPC G06Q 30/0239; G06Q 30/0215; G06Q 30/0211

(57) ABSTRACT

An information processing method and device. The method comprises: acquiring path information of sharing information of an online commodity in a process of being shared by respective levels of users, and operation information of respective levels of users for the sharing information (201); generating, according to the path information and operation information, user feature information corresponding to each level of user (202); inputting the user feature information and commodity feature information of the online commodity into a pre-trained reward calculation model to obtain reward information corresponding to respective levels of users (203); and determining, on the basis of the reward information of the users, information to be pushed (204).

This application is a national stage of International Application No. PCT/CN2020/140158, filed on Dec. 28, 2020, which claims priority from Chinese Patent Application No. 202010129833.3, filed by BEIJING WODONG TIANJUN INFORMATION TECHNOLOGY CO., LTD. and BEIJING JINGDONG CENTURY TRADING CO., LTD., on Feb. 28, 2020, titled “Information Processing Method and Information Processing Apparatus”. Both of the aforementioned applications are hereby incorporated by reference in their entireties.

### TECHNICAL FIELD

Embodiments of the present disclosure relate to the field of computer technology, and specifically to an information processing method and an information processing apparatus.

### BACKGROUND

With the development of big data and the Internet, community group purchase is playing an increasingly important role in economic activities. Community group purchase is a new form of online group purchase. It is a way in which group leaders organize consumers to purchase goods at low prices in a virtual community. On the one hand, community group purchase provides some aggregated consumers, and on the other hand, it can realize cooperation and mutual assistance between users. In the community group purchase scenario, the relevant information push method is usually that the group leader determines the user's needs according to the text input by the users in the group, so as to push the information to the group.

### SUMMARY

Embodiments of the present disclosure propose an information processing method and an information processing apparatus.

In a first aspect, an embodiment of the present disclosure provides an information processing method, the method includes: acquiring path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process; generating, based on the path information and the operation information, user feature information corresponding to a user at each level, the user feature information is used to represent a contribution of a user corresponding to the user feature information in the sharing process of the online commodity; inputting the user feature information and commodity feature information of the online commodity into a pre-trained reward calculation model, to obtain reward information corresponding to the user at each level; determining information to be pushed based on the reward information of the user at each level.

In a second aspect, an embodiment of the present disclosure provides an information processing apparatus, the apparatus includes: an information acquiring unit, configured to acquire path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process; a feature information generating unit, configured to generate, based on the path information and the operation information, user feature information corresponding to a user at each level, the user feature information is used to represent a contribution of a user corresponding to the user feature information in the sharing process of the online commodity; a reward information generating unit, configured to input the user feature information and commodity feature information of the online commodity into a pre-trained reward calculation model, to obtain reward information corresponding to the user at each level; and a push information generating unit, configured to determine information to be pushed based on the reward information of the user at each level.

In a third aspect, an embodiment of the present disclosure provides a computer-readable medium on which a computer program is stored, here, when the computer program is executed by a processor, the method as described in any embodiment of the first aspect is implemented.

In a fourth aspect, an embodiment of the present disclosure provides an electronic device, which includes: one or more processors; a storage device on which one or more programs are stored; where the one or more programs when executed by the one or more processors cause the one or more processors to implement the method according to any embodiment of the first aspect.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an example system architecture in which an embodiment of the present disclosure may be applied;

FIG. 2 is a flowchart of an embodiment of the information processing method according to the present disclosure;

FIG. 3 is a schematic diagram of an application scenario of the information processing method according to the present disclosure;

FIG. 4 is a flowchart of another embodiment of the information processing method according to the present disclosure;

FIG. 5 is a schematic structural diagram of an embodiment of the information processing apparatus according to the present disclosure;

FIG. 6 is a schematic structural diagram of a computer system adapted to implement embodiments of the present disclosure.

### DETAILED DESCRIPTION OF EMBODIMENTS

The present disclosure is further described below in detail by combining the accompanying drawings and the embodiments. It may be appreciated that detailed embodiments described herein are merely used for explaining the relevant invention, rather than limiting the invention. In addition, it should also be noted that, for ease of description, only the parts related to the relevant invention are shown in the accompanying drawings.

It should be noted that embodiments in the present disclosure and the features in the embodiments may be combined with each other on a non-conflict basis. The present disclosure will be described below in detail with reference to the accompanying drawings and in combination with the embodiments.

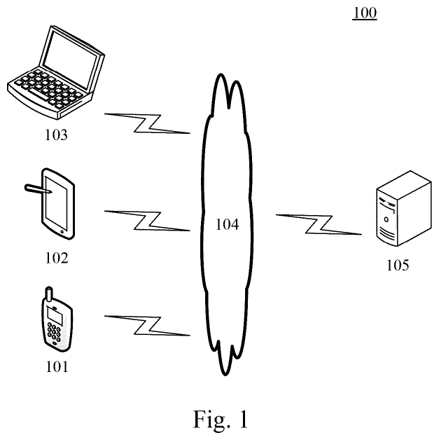

FIG. 1 illustrates an example system architecture 100 in which the information processing method of the present disclosure may be applied.

As shown in FIG. 1, the system architecture 100 may include terminal device(s) 101, 102, 103, a network 104, and a server 105. The network 104 is used to provide a medium of communication links between the terminal device(s) 101, 102, 103 and the server 105. The network 104 may include various types of connection, for example, wired or wireless communication links, or optical fiber cables, etc.

The terminal device(s) 101, 102, 103 may be hardware device(s) or software that support network connection for data interaction and data processing. When being the hardware, the terminal device(s) 101, 102, 103 may be various electronic devices that support functions such as information interaction, network connection, and image capture, including but not limited to smartphones, tablet computers, cameras, video cameras, e-book readers, laptop and desktop computers, etc. When being the software, the terminal device(s) 101, 102, 103 may be installed in the above listed electronic devices. The terminal device(s) may be implemented as a plurality of pieces of software or a plurality of software modules for providing a distributed service, or as a single piece of software or a single software module, which will not be specifically defined here.

The server 105 may be a server that provides various services, for example, a server that provides functions such as data analysis and processing, data transmission, and the like to the terminal device(s) 101, 102, 103. The server may store or analyze various data received, and feed back the processing results to the terminal device.

It should be noted that the information processing method provided by the embodiments of the present disclosure may be executed by the terminal device(s) 101, 102, 103, may also be executed by the server 105, or may be partially executed by the terminal device(s) 101, 102, 103, while the other part is performed by the server 105. Correspondingly, the information processing apparatus may be provided in the terminal device(s) 101, 102, 103, or in the server 105, and may be partially provided in the terminal device(s) 101, 102, 103, while the other part is provided in the server 105, which will not be specifically defined here.

It should be noted that the server may be hardware or software. When being hardware, the server may be implemented as a distributed server cluster composed of multiple servers, or may be implemented as a single server. When being the software, the server may be implemented as a plurality of pieces of software or a plurality of software modules for providing a distributed service, or as a single piece of software or a single software module, which will not be specifically defined here.

It should be understood that the numbers of the terminal devices, the networks and the servers in FIG. 1 are merely illustrative. Any number of terminal devices, networks and servers may be provided based on actual requirements.

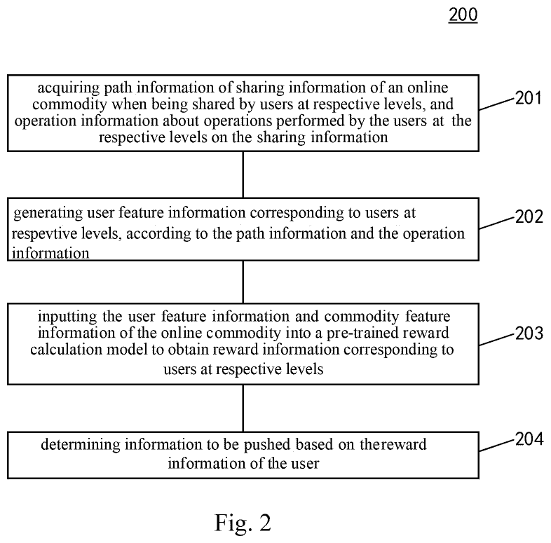

Further referring to FIG. 2, FIG. 2 illustrates a flow 200 of an embodiment of the information processing method, which includes the following steps:

Step 201, acquiring path information of sharing information of an online commodity in a sharing process of that the sharing information is shared by users at respective levels, and operation information about operations performed on the sharing information by users at the respective levels.

In this embodiment, the execution body (for example, the terminal device or the server shown in FIG. 1) of the information processing method may acquire the path information of the sharing information of the online commodity in the process of that the sharing information is shared by users at respective levels, and the operation information about the operations performed by the users at the respective levels on the sharing information.

The sharing information is used to represent a purchase address of the online commodity, for example, may be information such as network link corresponding to a purchase address of the online commodity, two-dimensional code corresponding to a purchase address of the online commodity, and the like. The sharing information is shared to other users through the sharing operation of a user at each level on the terminal device.

The users at respective levels are used to represent the users indicated by respective path nodes in the sharing process, and the path information is used to represent a propagation path of the commodity information among the users at the respective levels. The operations represented by the operation information may be various operations performed by the users at the respective levels based on the sharing information, including but not limited to: purchasing the online commodity, favoriting operation on the online commodity, browsing the online commodity, and entering shopping experience information about the online commodity.

As an example, if user A shares a shopping two-dimensional code of a certain type of TV, which is an online commodity, to group X in an instant messaging application through a smartphone, user B in the group X browses the TV indicated by the shopping two-dimensional code and shares the shopping two-dimensional code of the TV to another group Y in an instant messaging application, and user C in the group Y purchases a TV of this type according to the shopping two-dimensional code. Then the propagation path of the TV of this type is “user A→user B→user C”, and the user at each level in the users of the respective levels is user A, user B, user C, respectively, the operation information corresponding to user A is sharing the online commodity, the operation information corresponding to user B is browsing and sharing the online commodity, and the operation information corresponding to user C is purchasing the online commodity.

In this embodiment, starting from the user who initially shares the sharing information, the levels of the users may be determined according to the order of sharing of the sharing information, and the same level may include any number of users. Further referring to the above example, user A is a first-level user, user B is a second-level user, and user C is a third-level user, that is, user A is a superior user of user B, and user B is a superior user of user C. If user D and user E in group X also browse the shopping two-dimensional code of the TV, user D and user E are secondary users at the same level as user B.

In this embodiment, when the sharing information is shared by a user, identification information that uniquely identifies the user's identity may be added to the sharing information.

It should be noted that the execution body of this step may be a terminal device or a server. When the terminal device has an information acquisition function, the execution body of this step may be the terminal device with an information acquisition function; otherwise, the execution body of this step may be the server with an information acquisition function.

Step 202, generating, based on the path information and the operation information, a user feature information corresponding to a user at each level.

In this embodiment, according to the acquired path information and operation information, the execution body may generate the user feature information corresponding to the user at each level.

The user feature information is used to represent the contribution of a user corresponding to the user feature information in the sharing process of the online commodity.

In this embodiment, since in the order of sharing indicated by the path information, the operation information of the sharing users at respective levels, who are subsequent to a certain user is performed on the basis of the sharing information shared by this certain user, the operation information of the sharing users at the respective levels, who are subsequent to this certain user in the order of sharing indicated by the path information, may be used as this certain user's contribution.

Further referring to the above example, in the process of sharing the TV of this type, the contribution of user A includes: user B, user D, and user E browse the online commodity, and user C purchases the online commodity. The contribution of user B is: user C purchases the online commodity.

In this embodiment, the contribution of a user at each level in the process of sharing the online commodity may be used as the feature information of this user. In some optional implementations, a numericalized feature information may be obtained by normalizing the operation information. For example, corresponding numerical values may be preset according to various operation information, so as to obtain the numericalized feature information.

Step 203, inputting the user feature information and commodity feature information of the online commodity into a pre-trained reward calculation model, to obtain reward information corresponding to a user at each level.

In this embodiment, the obtained user feature information and the obtained commodity feature information of the online commodity are used as the inputs of the pre-trained reward calculation model, and the reward information corresponding to the user at each level may be obtained. The reward information may be, for example, electronic red envelopes, vouchers, coupons, and the like. The commodity feature information may be, for example, attribute information such as the type of the online commodity, price of the online commodity, and the like.

Here, the above reward calculation model may be a two-dimensional table or a database, in which user feature information, commodity feature information of the online commodity, reward information of the users at respective levels, and the corresponding relationships between the user feature information, the commodity feature information and the reward information, are stored in association with each other. The above reward calculation model may also be a convolutional neural network trained with machine learning algorithms (such as eXtreme Gradient Boosting (XGBoost), mini-batch gradient descent (MBGD)).

In some optional implementations, the above reward calculation model may be trained, via the following steps, by the above execution body or an electronic device communicatively connected to the above execution body:

First, acquiring a training sample set. Here, the training samples in the training sample set include user feature information, commodity feature information, and reward information. Then, using the XGBoost (eXtreme Gradient Boosting) algorithm, taking the user feature information and the commodity feature information included in a training sample in the training sample set as inputs, taking the reward information corresponding to the input user feature information and the input commodity feature information as an expected output, thus the reward calculation model is trained and obtained.

Exemplarily, the user feature information and the commodity feature information included in a piece of training sample in the training sample set may be input into an initial model to obtain actual output data calculated by the initial model. Here, the actual output data may be the reward information actually output by the initial model. Then, the loss function in the XGBoost algorithm is used to calculate the difference value between the actual output reward information and the corresponding reward information included in the piece of training sample. If the difference value is less than or equal to a preset difference threshold, the current initial model may be used as the reward model; if the difference value is greater than the above preset difference threshold, the model parameters of the current initial model may be adjusted, and the model with the adjusted parameters may be used as an initial model for a next training.

Here, the initial model may be a convolutional neural network model with network structures such as AlexNet, VGG and ResNet.

It may be understood that, compared with the prior art, this optional implementation adopts the XGBoost algorithm to train the reward calculation model, so that the reward calculation model obtained by training can generate more accurate reward information corresponding to users at respective levels. Moreover, under the condition of achieving the same training effect, the XGBoost algorithm requires fewer iterations, and multi-threading can be enabled when selecting the best split point, which greatly improves the efficiency of model iteration and calculation.

Step 204, determining an information to be pushed based on the reward information of the user.

In this embodiment, the execution body may determine the information to be pushed according to the reward information obtained by the reward calculation model. Particularly, the information to be pushed about the online commodity may be determined according to the online commodity to which the reward represented by the reward information is applicable.

As an example, the reward information may be a coupon for an online commodity of electrical appliances. According to the coupon, the execution body may determine that the information to be pushed is information to be pushed about a commodity of electrical appliances, and then send the information to be pushed to the corresponding user.

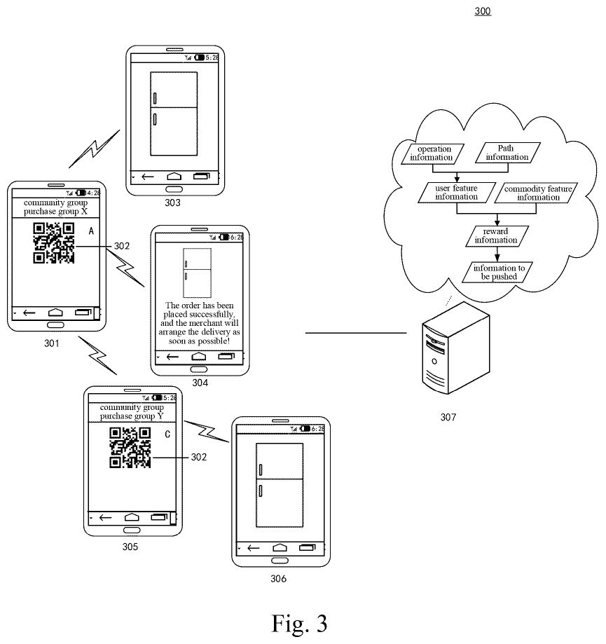

Further referring to FIG. 3, FIG. 3 is a schematic diagram of an application scenario of the information processing method according to this embodiment. In the application scenario of FIG. 3, the user A sends the sharing information 302 to the “community group purchase group X” through the mobile terminal 301, here the sharing information 302 is a two-dimensional code representing the purchase address of a refrigerator of a certain type. Five users in the “community group purchase group X” browsed the refrigerator shopping webpage according to the instruction of the sharing information 302, including user B who browsed the refrigerator shopping webpage through the terminal device 303. Moreover, user C in the “community group purchase group X” purchased the refrigerator of this certain type through the terminal device 304, and user D sends the sharing information 302 to a “community group purchase group Y” through the terminal device 305. Six of the users in the “community group purchase group Y” browsed the shopping webpage of the refrigerator according to the instruction of the sharing information 302, including user E who browsed the shopping webpage of the refrigerator through the terminal device 306. The server 307 acquires the path information of the refrigerator's sharing information 302 in the process of that the sharing information is shared by users at respective levels, and the operation information performed on the sharing information by the users at respective levels; and the server 307 generates user feature information corresponding to the users at the respective levels according to the path information and the operation information. Here, the feature information of user A is: eleven browsing users and one purchasing user; the feature information of user B is: six browsing users. Then, the server 303 inputs the user feature information and the commodity feature information of the online commodity into the pre-trained reward calculation model, and obtains the reward information corresponding to users at the respective levels. For example, the reward information for user A is a 30 yuan cash coupon, and the reward information for user E is a 10 yuan cash coupon. Finally, the server determines the information to be pushed based on the reward information of the users.

In the method provided by the above embodiment of the present disclosure, acquiring path information of a piece of sharing information of an online commodity in the process of that the sharing information is shared by users at respective levels, and operation information about operations performed by users at the respective levels on the sharing information; then, according to the path information and the operation information, generating user feature information corresponding to the users at respective levels; finally, inputting the user feature information and commodity feature information of the online commodity into a pre-trained reward calculation model to obtain reward information corresponding to the users the at the respective levels. Thus, the reward information corresponding to the users at the respective levels may be determined, which is conducive to increasing the frequency of sharing the sharing information by users and increasing the number of shopping users. Based on the user's reward information, the information to be pushed can be determined, so that the information can be pushed more targeted.

In some optional implementations of this embodiment, the above execution body may also perform the following steps:

First, sending the reward corresponding to a piece of reward information to an account of the user corresponding to the piece of reward information.

In this implementation, the account information of the user corresponding to the piece of reward information may be acquired in advance, and the reward corresponding to the piece of reward information is sent to the account of the user corresponding to the piece of reward information.

Then, according to the reward information corresponding to the users at respective levels, generating reward summary information, and sending the reward summary information to respective accounts of the users at the respective levels.

In this embodiment, the execution body may share the reward summary information among users at the respective levels, so that users at the respective levels can know the feature information of other users and the rewards they get, so as to encourage users to actively share the sharing information about the online commodity and improve sales volume of the online commodity.

In some optional implementations of this embodiment, the above execution body may also perform the following steps:

First, analyzing a change trend information of the sales volume of the online commodity after the user acquires the reward corresponding to the reward information; then, according to the change trend information, adjusting the reward information output by the pre-trained reward calculation model.

In this implementation method, the reward information output by the reward calculation model may be adjusted according to the change trend represented by the change trend information of sales volume of the online commodity, so that the reward information can better motivate the user's desire to share and further increase the number of users purchasing the online commodity.

For example, according to the user's feature information, when a weight of a reward for the browsing operation in the reward information corresponding to a certain commodity is increased and the reward for the operation of favoriting in the reward information is reduced, the sales volume of this commodity has a downward trend. Thus, the reward for the operation of favoriting in the reward information needs to be increased, or the reward weight of the operation of browsing in the reward information needs to be reduced.

In this embodiment, the pre-trained reward calculation model is adjusted according to the change trend represented by the change trend information of sales volume of the online commodity, which improves the intelligence of the present disclosure and can obtain more accurate reward information.

In some optional implementations of this embodiment, the above execution body may also perform the following steps:

First, analyzing a change trend information of times of sharing the sharing information after the user acquires the reward corresponding to the reward information; then, adjusting, according to the change trend information, the reward information output by the pre-trained reward calculation model.

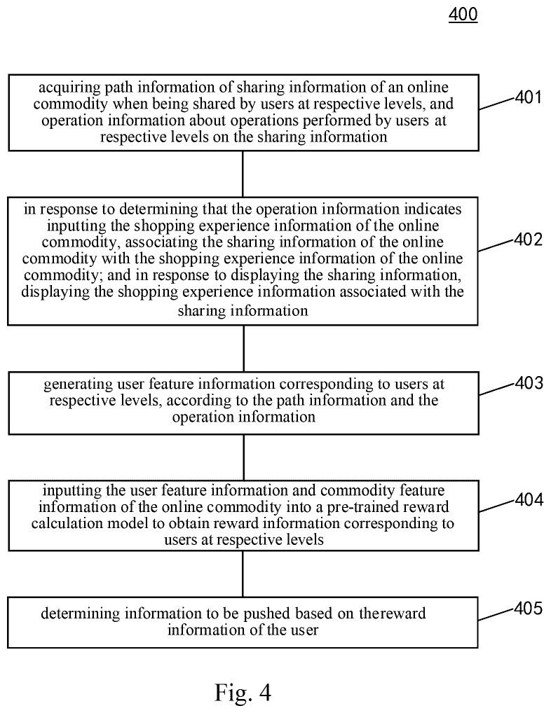

Further referring to FIG. 4, FIG. 4 illustrates a schematic flow 400 of another embodiment of the information processing method according to the present disclosure, which includes the following steps:

Step 401, acquiring path information of sharing information of an online commodity in the process of that the sharing information is shared by users at respective levels, and operation information about operations performed on the sharing information by users at the respective levels.

In this embodiment, step 401 is performed in a similar way to step 201, and details are not repeated here.

Step 402, in response to determining that the operation information indicates inputting shopping experience information targeting at the online commodity, associating the sharing information of the online commodity with the shopping experience information targeting at the online commodity; and in response to displaying the sharing information, displaying the shopping experience information associated with the sharing information.

In this embodiment, during the sharing process of the sharing information, the shopping experience information targeting at the online commodity may be simultaneously displayed on the interface for displaying the shared information. The user to be shared with does not have to browse the shopping page of the online commodity, and may intuitively view the shopping experience information of the online commodity while viewing the shared information. The user can quickly determine whether to purchase or share the shared information, thereby improving the efficiency in sharing the sharing information.

Step 403, generating user feature information corresponding to users at the respective levels, according to the path information and the operation information.

In this embodiment, step 403 is performed in a similar way to step 202, and details are not repeated here.

Step 404, inputting the user feature information and commodity feature information of the online commodity into a pre-trained reward calculation model to obtain reward information corresponding to a user at each level.

In this embodiment, step 404 is performed in a similar way to step 203, and details are not repeated herein.

Step 405, determining information to be pushed based on the reward information of the user.

In this embodiment, step 405 is performed in a similar way to step 204, and details are not repeated herein.

It can be seen from this embodiment that, compared with the embodiment corresponding to FIG. 2, the flow 400 of the information processing method in this embodiment illustrates in detail that in the sharing process of the sharing information, the interface for displaying the sharing information can display shopping experience information targeting at the online commodity simultaneously. The user to be shared with does not have to browse the shopping page of the online commodity, and can intuitively view the shopping experience information targeting at the online commodity while viewing the sharing information. The user can quickly determine whether to purchase or share the sharing information, thereby improving the efficiency in sharing the sharing information.

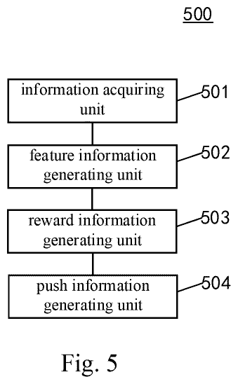

Further referring to FIG. 5, as an implementation of the methods shown in the above drawings, the present disclosure provides an embodiment of an information processing apparatus. The embodiment of the apparatus corresponds to the embodiment of the method shown in FIG. 2. Particularly, the apparatus may be applied in various electronic devices.

As shown in FIG. 5, the information processing apparatus includes: an information acquiring unit 501 configured to acquire path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process; a feature information generating unit 502 configured to generate, based on the path information and the operation information, user feature information corresponding to a user at each level, the user feature information is used to represent a contribution of a user corresponding to the user feature information in the sharing process of the online commodity; a reward information generating unit 503 configured to input the user feature information and commodity feature information of the online commodity into a pre-trained reward calculation model, to obtain reward information corresponding to the user at each level; and a push information generating unit 504 configured to determine information to be pushed based on the reward information of the user at each level.

In some embodiments, the above apparatus also includes a sharing unit (not shown in the drawings), which is configured to: send a reward corresponding to a piece of reward information to an account of a user corresponding to the piece of reward information; generate reward summary information according to the reward information corresponding to the users at the respective levels, and send the reward summary information to respective accounts of the users at the respective levels.

In some embodiments, the above apparatus also includes a first adjusting unit (not shown in the drawings), which is configured to: analyze change trend information of sales volume of the online commodity after the user acquires the reward corresponding to the reward information; and adjust, according to the change trend information, the reward information output by the reward calculation model.

In some embodiments, the above apparatus also includes a second adjusting unit (not shown in the drawings), which is configured to: analyze a change trend information of times of sharing the sharing information after the user acquires a reward corresponding to the reward information; and adjust, according to the change trend information, the reward information output by the reward calculation model.

In some embodiments, the operations indicated by the above operation information include: purchasing the online commodity, favoriting operation on the online commodity, browsing the online commodity, and inputting shopping experience information targeting at the online commodity.

In some embodiments, the above apparatus also includes an associating unit (not shown in the drawings), which is configured to: in response to determining that the operation information indicates inputting shopping experience information targeting at the online commodity, associate the sharing information of the online commodity with the shopping experience information targeting at the online commodity; and display, in response to displaying the sharing information, display the shopping experience information associated with the sharing information.

In this embodiment, the information processing apparatus can determine the reward information corresponding to users at respective levels more accurately, which enriches the way of information generation.

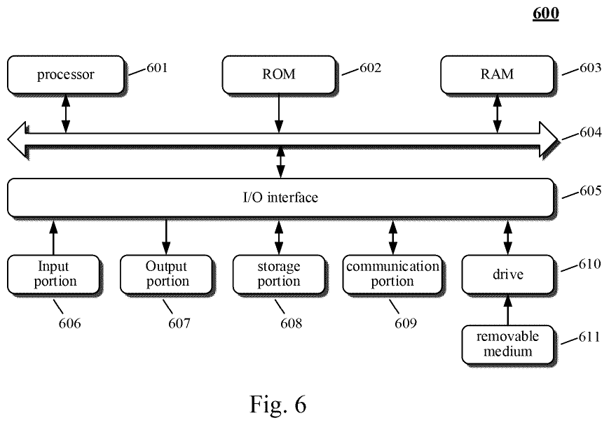

Referring next to FIG. 6, FIG. 6 illustrates a schematic structural diagram of a computer system 600 adapted to implement the apparatus (e.g., device(s) 101, 102, 103 and 105 shown in FIG. 1) according to embodiments of the present disclosure. The device shown in FIG. 6 is merely an example, and should not bring any limitations to the functions and usage scope of the embodiments of the present application.

As shown in FIG. 6, the computer system 600 may include processor (for example, central processing unit (CPU)) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The processor 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, etc.; an output portion 607 including a cathode-ray tube (CRT), a liquid crystal display device (LCD), a speaker, etc.; the storage portion 608 including hard disk, etc.; and a communication portion 609 including network interface cards such as LAN cards, modems, etc. The communication portion 609 performs communication processing via a network such as the Internet. A drive 610 is also connected to the I/O interface 605 as needed. A removable medium 611, such as magnetic disk, optical disk, magneto-optical disk, semiconductor memory, etc., is mounted on the drive 610 as needed, so that a computer program read therefrom is installed into the storage portion 608 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program includes program codes for executing the method as illustrated in the flow chart. In such an embodiment, the computer program may be downloaded and installed from a network via the communication portion 609, or may be installed from the removable medium 611. The computer program, when executed by the processor 601, implements the above mentioned functionalities as defined by the methods of the embodiments of the present disclosure.

It should be noted that the computer-readable medium in embodiments of the present disclosure may be computer-readable signal medium or computer-readable storage medium or any combination of the above two. An example of the computer-readable storage medium may include, but not limited to: electric, magnetic, optical, electromagnetic, infrared, or semiconductor systems, apparatus, elements, or a combination any of the above. A more specific example of the computer-readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the embodiments of the present disclosure, the computer-readable storage medium may be any physical medium containing or storing programs which can be used by a command execution system, apparatus or element or incorporated thereto. In the embodiments of the present disclosure, the computer-readable signal medium may include data signal in the base band or propagating as parts of a carrier, in which computer-readable program codes are carried. The propagating signal may take various forms, including but not limited to: an electromagnetic signal, an optical signal or any suitable combination of the above. The signal medium that can be read by computer may be any computer-readable medium except for the computer-readable storage medium. The computer-readable medium is capable of transmitting, propagating or transferring programs for use by, or used in combination with, a command execution system, apparatus or element. The program codes contained on the computer-readable medium may be transmitted with any suitable medium including but not limited to: wireless, wire, optical cable, RF medium etc., or any suitable combination of the above.

A computer program code for executing operations in the embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the apparatuses, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The described units involved in embodiments of the present disclosure may be implemented by means of software or hardware. The described units may also be provided in a processor. For example, the processor may be described as: a processor including an information acquiring unit, a feature information generating unit, a reward information generating unit and a push information generating unit. Here, the names of these units do not in some cases constitute a limitation to such units themselves. For example, the reward information generating unit may alternatively be described as “a unit that inputs the user feature information and the commodity feature information of the online commodity into a pre-trained reward calculation model to obtain reward information corresponding to the users at respective levels”.

As another aspect, the present application also provides a computer-readable medium. The computer-readable medium may be included in the device described in the above embodiments, or may exist alone without being assembled into the device. The above computer-readable medium carries one or more programs, and when the above one or more programs are executed by the apparatus, the computer device: acquiring path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process; generating, based on the path information and the operation information, user feature information corresponding to a user at each level, the user feature information is used to represent a contribution of a user corresponding to the user feature information in the sharing process of the online commodity; inputting the user feature information and commodity feature information of the online commodity into a pre-trained reward calculation model, to obtain reward information corresponding to the user at each level; and determining information to be pushed based on the reward information of the user at each level.

The above description only provides an explanation of the preferred embodiments of the present disclosure and the technical principles used. It should be appreciated by those skilled in the art that the inventive scope of the embodiments of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the embodiments of the present disclosure are examples.

1. An information processing method, comprising:
acquiring path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process;
generating, based on the path information and the operation information, user feature information corresponding to a user at each level, the user feature information is used to represent a contribution of a user corresponding to the user feature information in the sharing process of the online commodity;
inputting the user feature information and commodity feature information of the online commodity into a pre-trained reward calculation model, to obtain reward information corresponding to the user at each level; and
determining information to be pushed based on the reward information of the user at each level.

2. The method according to claim 1, wherein, after inputting the user feature information and the commodity feature information of the online commodity into the pre-trained reward calculation model, to obtain the reward information corresponding to the user at each level, the method further comprises:
sending a reward corresponding to a piece of reward information to an account of a user corresponding to the piece of reward information; and
generating reward summary information according to the reward information corresponding to the users at the respective levels, and sending the reward summary information to respective accounts of the users at the respective levels.

3. The method according to claim 1, wherein the method further comprises:
analyzing change trend information of sales volume of the online commodity after the user acquires the reward corresponding to the reward information; and
adjusting, according to the change trend information, the reward information output by the reward calculation model.

4. The method according to claim 1, wherein the method further comprises:
analyzing a change trend information of times of sharing the sharing information after the user acquires a reward corresponding to the reward information; and
adjusting, according to the change trend information, the reward information output by the reward calculation model.

5. The method according to claim 1, wherein operations indicated by the operation information include: purchasing the online commodity, favoriting operation on the online commodity, browsing the online commodity, and inputting shopping experience information targeting at the online commodity.

6. The method according to claim 5, wherein the method further comprises:
in response to determining that the operation information indicates inputting shopping experience information targeting at the online commodity, associating the sharing information of the online commodity with the shopping experience information targeting at the online commodity; and
in response to displaying the sharing information, displaying the shopping experience information associated with the sharing information.

7. An information processing apparatus, comprising:
one or more processors; and
a storage apparatus, configured to store one or more programs,
wherein the one or more programs, when executed by the one or more processors, cause the one or more processors to implement operations, the operations comprising:
acquiring path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process;
generating, based on the path information and the operation information, user feature information corresponding to a user at each level, the user feature information is used to represent a contribution of a user corresponding to the user feature information in the sharing process of the online commodity;
inputting the user feature information and commodity feature information of the online commodity into a pre-trained reward calculation model, to obtain reward information corresponding to the user at each level; and
determining information to be pushed based on the reward information of the user at each level.

8. The apparatus according to claim 7, wherein the operations further comprises:
sending a reward corresponding to a piece of reward information to an account of a user corresponding to the piece of reward information; generating reward summary information according to the reward information corresponding to the users at the respective levels, and sending the reward summary information to respective accounts of the users at the respective levels.

9. The apparatus according to claim 7, wherein the operations further comprises:
analyzing change trend information of sales volume of the online commodity after the user acquires the reward corresponding to the reward information; and adjusting, according to the change trend information, the reward information output by the reward calculation model.

10. The apparatus according to claim 7, wherein the operations further comprises:
analyzing a change trend information of times of sharing the sharing information after the user acquires a reward corresponding to the reward information; and adjusting, according to the change trend information, the reward information output by the reward calculation model.

11. The apparatus according to claim 7, wherein operations indicated by the operation information include: purchasing the online commodity, favoriting operation on the online commodity, browsing the online commodity, and inputting shopping experience information targeting at the online commodity.

12. The apparatus according to claim 11, wherein the operations further comprises:
in response to determining that the operation information indicates inputting shopping experience information targeting at the online commodity, associating the sharing information of the online commodity with the shopping experience information targeting at the online commodity; and displaying, in response to displaying the sharing information, the shopping experience information associated with the sharing information.

13. A non-transitory computer readable medium, storing a computer program, wherein the program, when executed by a processor, cause the processor to implement operations, the operations comprising:
acquiring path information of sharing information of an online commodity in a process of that the sharing information is shared by users at respective levels, and operation information about operations performed by the users at the respective levels on the sharing information, wherein the path information is used to represent a propagation path of commodity information among the users at the respective levels, the sharing information is used to represent a purchase address of the online commodity, and the users at the respective levels are used to represent users indicated by respective path nodes in the sharing process;
generating, based on the path information and the operation information, user feature information corresponding to a user at each level, the user feature information is used to represent a contribution of a user corresponding to the user feature information in the sharing process of the online commodity;
inputting the user feature information and commodity feature information of the online commodity into a pre-trained reward calculation model, to obtain reward information corresponding to the user at each level; and
determining information to be pushed based on the reward information of the user at each level.

14. (canceled)

15. The medium according to claim 13, wherein the operations further comprise:
sending a reward corresponding to a piece of reward information to an account of a user corresponding to the piece of reward information; generating reward summary information according to the reward information corresponding to the users at the respective levels, and sending the reward summary information to respective accounts of the users at the respective levels.

16. The medium according to claim 13, wherein the operations further comprise:
analyzing change trend information of sales volume of the online commodity after the user acquires the reward corresponding to the reward information; and adjusting, according to the change trend information, the reward information output by the reward calculation model.

17. The medium according to claim 13, wherein the operations further comprise:
analyzing a change trend information of times of sharing the sharing information after the user acquires a reward corresponding to the reward information; and adjusting, according to the change trend information, the reward information output by the reward calculation model.

18. The medium according to claim 13, wherein operations indicated by the operation information include: purchasing the online commodity, favoriting operation on the online commodity, browsing the online commodity, and inputting shopping experience information targeting at the online commodity.

19. The medium according to claim 18, wherein the operations further comprise:
in response to determining that the operation information indicates inputting shopping experience information targeting at the online commodity, associating the sharing information of the online commodity with the shopping experience information targeting at the online commodity; and displaying, in response to displaying the sharing information, the shopping experience information associated with the sharing information.
